(19) United States
(12) Patent Application Publication
(10) Pub. No.: US 2009/0186775 A1
(43) Pub. Date: Jul. 23, 2009

(54) Method and device for dual array hybridization karyotype analysis

(75) Inventors: Norma Nowak, Buffalo, NY (US); Jeffrey M. Conroy, Williamsville, NY (US); Anthony Johnson, Buffalo, NY (US)

Correspondence Address: LAWSON & WEITZEN, LLP, 88 BLACK FALCON AVE, SUITE 345, BOSTON, MA, 02210, US

(73) Assignee: Empire Genomics, LLC Organization, Buffalo, NY (US)

(21) Appl. No.: 12/353,395

(22) Filed: Jan. 14, 2009

Related U.S. Application Data
(60) Provisional application No. 61/011,182, filed on Jan. 15, 2008.

(51) Int. Cl. C40B 30/04; C40B 60/12

(52) U.S. Cl. 506/9; 506/39

(57) ABSTRACT

A method, a device and a platform for a dual assay, co-hybridization of labeled nucleic acid molecules utilizing two independent microarray platforms are provided herein. The dual hybridization method and device, including for example, each of a BAC based array and an oligonucleotide array provide simultaneous replication and/or validation of data for a single assay sample and in the same container, using two or more microarray slides.

### RELATED APPLICATION

The application claims the benefit of U.S. provisional application Ser. No. 61/011,182 filed Jan. 13, 2008 entitled “Method and device for dual array hybridization karyotype analysis”, having inventors Norma Nowak, Jeffrey M. Conroy and Anthony Johnson, which is hereby incorporated herein by reference in its entirety.

### FIELD OF THE INVENTION

The invention provides devices and method for multiplex simultaneous Karyotype analyses of a single sample of genetic material using a plurality of Comparative Genomic Hybridizations with DNA based microarrays.

### BACKGROUND

The structure and enumeration of chromosomes have been analyzed using classic cytogenetic banding techniques (i.e. Giemsa banding) the classical standard for diagnostic analysis of chromosome aberrations. However, karyotype analysis has several limitations: poor resolution (10-20 Mb) compared to recently developed molecular techniques; dependence on actively dividing cells; difficulty of preparing metaphase chromosomes from tumor cells; a 7 to 21 day turn around time; and requirement for highly trained technologists interpretation results. In diagnosis of cancer, conventional cytogenetics has facilitated identification of chromosome abnormalities, however fresh samples of viable tissue are required, and the data for individual cells does not analyze the entire tumor landscape. These limitations to conventional cytogenetics are significant medically because most tumors are heterogeneous, viz., non-tumor tissue is included in the pathology sample.

More recent molecular cytogenetic methodologies were developed to examine copy number aberrations i.e., DNA content of cells, without the need for cell culturing. Metaphase Comparative Genomic Hybridization (CGH) is capable of detecting gains and losses in genomic regions 5-10 Mb in length. This technology has been further developed into a microarray format of DNA targets or array CGH, particularly two types of array comparative genomic hybridization (aCGH) platforms based on nature of the arrayed targets: BAC based microarrays and oligonucleotide microarrays.

The challenges of standardization and reproducibility of aCGH as a potential diagnostic tool are being addressed, with particular potential for both BAC and oligonucleotide CGH based studies on archival cancer samples. Eliminating problems associated with poor quality DNA and developing the means to identify heterogeneity within a sample allows interrogation of large clinical tumor banks, facilitating identification and validation of molecular cytogenetic biomarkers that indicate the biological behavior (aggressiveness), invasive potential, and the most applicable treatment strategy of genetically-characterized tumor subgroups or patient-specific tumors.

Important remaining issues for diagnostic applications include standardization, reproducibility and validation. BAC arrays have the advantage of being the most reproducible platform. Each clone on the array can be further utilized as a FISH probe for copy number aberration (CNA) validation.

Under present practices, standard aCGH analyses utilize a single slide arrayed with target nucleic acids; in clinical settings, confirmatory experiments on a second independent array are required. This second step requires the utilization of additional patient material, however where the original sample is often small in size, and finite in amount. Further, aCGH technologies have increased numbers of probes or targets on slides to increase the genetic resolution. A limiting factor in this trend is the finite surface area of the slide, and the need to process additional slides independently to achieve the desired resolution.

There is a need for a technology that combines the BAC and oligonucleotide platforms in a single aCGH reaction allowing for the accurate comparison of platforms under the same conditions, simultaneous validation of the results obtained from the two platforms in a single array assay, and minimization and preservation of sample material required for analysis.

### SUMMARY

An aspect of the invention herein provides a device for performing simultaneous dual array comparative genomic hybridizations using a single aqueous sample of nucleic acid, the device comprising:
a first substrate array having a first array printed surface and a first array non-printed surface, wherein the first array comprises a first plurality of sequence targets, each target immobilized to a discrete and known spot on the first array printed surface;
a gasket adjacent to and in contact with the first array printed surface, wherein the gasket forms a liquid-tight seal with the first array printed surface;
a second substrate array having a second array printed surface and a second array non-printed surface, wherein the second array comprises a second plurality of sequence targets, each target immobilized to a discrete and known spot on the second array printed surface, wherein the second array printed surface contacts the gasket and the gasket forms a liquid-tight seal with the second array printed surface; and
a clamping device, wherein the clamping device has a cooperative relationship with the first array non-printed surface and the second array non-printed surface, wherein the sample is contracted to the first substrate and the second substrate, to perform simultaneous dual array.

The device according to an embodiment includes at least one selected from the group of: an epoxy layer between the gasket and each of the first array printed surface and the second array printed surface; a chamber with two rails; at least one elastic band; at least one strap; at least one hinge attached to each of the first substrate array and the second substrate array, wherein the first substrate array and the second substrate array are rotationally moveable by varying the angle of opening of the hinge; a vacuum seal; electromagnets; comprises two or more frames wherein at least one frame is magnetic; a cam; a coil spring; a leaf spring; pneumatic pressure; hydraulic pressure; a wedge; a toggle; metal clips; plastic clips. For example, the gasket includes a deformable material; for example, the deformable material is at least one material selected from the group of rubber and plastic. In alternative embodiments, the rubber is natural or synthetic. The rubber further includes, in various embodiments, at least one material selected from the group consisting of latex, silicone, and liquid silicone. The plastic in various embodiments includes at least one polymer selected from the group of polyurethane, polyurethane foam, polyethylene, polypropylene, polybutylene, polystyrene, and polymethylpentene. The plastic polymer further includes at least one atom selected from the group consisting of oxygen, chlorine, fluorine, nitrogen, silicon, phosphorous, and sulfur.

In general, the immobilized sequence targets include at least one polynucleotide selected from the group consisting of: genomic DNA, mitochondrial DNA, cDNA, RNA, mRNA, tRNA, rRNA, siRNA, RNAi, and dsRNA, although the device is suitable for additional molecular classes as described herein. In certain embodiments, the first array sequence targets are substantially the same as the second array sequence targets. Alternatively, the first array sequence targets are different from the second array sequence targets. In certain embodiments, the resolution ability of first array is substantially the same as the second array resolution ability. Alternatively, the resolution ability of the first array is different from that of the second array. Alternatively the resolution ability of the first array is substantially equivalent to that of the second array.

In general, each sequence of the sequence targets is printed in a plurality of replicates on each of the first array and the second array. In an embodiment of device provided herein, the plurality of replicates include at least one different amount of at least one immobilized sequence target. In an embodiment of device provided herein, the immobilized sequence targets are covalently bound to a component of the substrate surfaces.

An embodiment of the device according to any of those described above further includes at least one immobilized sequence target spot as a positive control. An embodiment of the device according any of those described above further includes:
at least one spot as a negative control. For example, the negative control for human immobilized sequence targets is selected from at least one genomic nucleic acid consisting of: a non-animal such as a plant, a yeast or a bacterium; a non-vertebrate such as an insect or a sea urchin or any of the non-animals; a non-mammalian such as a bird, a reptile or any of the non-animals or non-vertebrates; a non-primate; and a non-human. For example, the negative control for is at least one genomic nucleic acid obtained from an organism such as: a prokaryote; a zebra fish; a virus; and a plant.

Another aspect of the invention herein provides a device for performing simultaneous dual binding assays using a single sample, the device comprising:
a first substrate array having a printed surface and a non-printed surface, wherein the first array comprises a first plurality of sequence targets, each target immobilized to a discrete and known spot on the first array printed surface;
a gasket adjacent to and in contact with the first array printed surface, wherein the gasket forms a liquid-tight seal with the first array printed surface;
a second substrate array having a printed surface and a non-printed surface, wherein the second array comprises a second plurality of sequence targets, each target immobilized to a discrete and known spot on the second array printed surface, wherein the second printed surface contacts the gasket and the gasket forms a liquid-tight seal with the second array printed surface; and
a clamping device, wherein the clamping device has a cooperative relationship with the first array non-printed surface and the second array non-printed surface. For example, in various embodiments of the device, the sequence targets are polynucleotides or polypeptides.

Also provided herein is a method for performing simultaneous dual array comparative genomic hybridizations with a single sample, the method comprising:
co-hybridizing simultaneously a mixture of a labeled test sample and a differently labeled reference sample to a first array of sequence targets on a first substrate surface and a second array of sequence targets on a second substrate surface, wherein the co-hybridizing comprises contacting an aliquot of the mixture to both of the first array and second array simultaneously, wherein the first array substrate surface and the second array substrate surface are physically discrete, and wherein the first array is a first plurality of sequence targets, each target immobilized to a discrete and known spot on the first substrate surface to form the first array of sequence targets, and the second array is a second plurality of sequence targets, each target immobilized to a discrete and known spot on the second substrate surface to form the second array of sequence targets.

In various related embodiments, the method further includes, prior to co-hybridizing, the steps of labeling the test sample, and labeling the reference sample, such that the test sample and the reference sample are differently labeled. For example, the labeled test sample and the differently labeled reference sample are calorimetrically or fluorescently labeled, and detecting is performed by a laser scanner. In various related embodiments, the method further includes, after cohybridizing, steps of detecting co-hybridization of each of the labeled test sample and the differently labeled reference sample to each of the first array and the second array. The method in a related embodiment further includes comparing an intensity of a signal from the labeled test sample hybridized with the differently labeled reference sample on the sequence targets to obtain a signal ratio. The method in a related embodiment further includes comparing the signal ratios at each discrete and known spot of the sequence targets of the first array with the signal ratios at each discrete and known spot of the sequence targets of the second array, thereby evaluating relative copy numbers of sequences present in the labeled sample compared to the reference sample that are bound to the sequence targets of each of the first and second arrays.

In a related embodiment of the method, the sequence targets are at least one polynucleotide selected from the group consisting of: genomic DNA, mitochondrial DNA, cDNA, RNA, mRNA, tRNA, rRNA, siRNA, RNAi, and dsRNA. In a related embodiment of the method each of the test sample and the reference sample is at least one polynucleotide selected from the group consisting of: genomic DNA, mitochondrial DNA, cDNA, RNA, mRNA, tRNA, rRNA, siRNA, RNAi, and dsRNA. In a related embodiment of the method prior to labeling, the method includes obtaining the test sample from at least one biological specimen selected from the group consisting of: a tissue; an embryo; a previously frozen embryo; an archived biopsy; a blood cell fraction; fractioned blood; embryonic cells obtained from maternal blood; urine; cerebral spinal fluid; amniotic fluid; cells obtained from amniotic fluid; chorionic villus; and an embryonic cell or embryo tissue.

In an embodiment of the method, the first array sequence targets are substantially the same as the second array sequence targets. Alternatively, the first array sequence targets are different from the second array sequence targets. In an embodiment of the method the first array resolution ability is substantially the same as the second array resolution ability. Alternatively, the first array resolution ability is different from the second array resolution ability.

Also provided herein is a method for performing simultaneous dual array binding assays with a single sample, the method including:
co-contacting simultaneously a mixture of a labeled test sample and a differently labeled reference sample to a first array of sequence targets on a first substrate surface and a second array of sequence targets on a second substrate surface, wherein the co-contacting comprises contacting an aliquot of the mixture to both of the first array and second array simultaneously, wherein the first array substrate surface and the second array substrate surface are physically discrete, and wherein the first array is a first plurality of sequence targets, each target immobilized to a discrete and known spot on the first substrate surface to form the first array of sequence targets, and the second array is a second plurality of sequence targets, each target immobilized to a discrete and known spot on the second substrate surface to form the second array of sequence targets. In an exemplary embodiment, the sequence targets are polypeptides or polynucleotides. substrate surface to form the second array of sequence targets. In another exemplary embodiment, the labeled test sample includes a plurality of low molecular weight compositions.

### BRIEF DESCRIPTION OF THE DRAWINGS

FIG. 1 is a drawing showing comparison of resolutions of different CGH technologies, for mapping and detecting chromosome aberrations.

FIG. 2 is a table showing correspondence of aCGH results among platforms for analysis of known HL-60 gains and losses by chromosome position (top) and novel copy number changes detected (bottom).

FIG. 3 is a bar graph showing standard deviation statistics of four replica aCGH experiments comparing HL60 DNA with a reference sample of lung DNA among analysis of five platforms. Data include a minimum, maximum, median, and 25^{th} and 75^{th} percentile provided as a box and whisker plot.

FIG. 4 is a set of data showing a comparison of tumor heterogeneity observed in sections from replicate FFPE blocks and other types of samples. Chromosomes 2, 8, 11 and X are shown as examples. Genomic DNA copy number aberrations or alterations (CNAs) on chromosomes 11 and X show similar profiles in nuclei and obtained from each of a frozen sample (panel A), an FFPE sample (panel B) and an amplified FFPE sample (panel C) taken from the same block. The aCGH profile of an alternate FFPE sample (panel D) shows CNAs distinct from A, B, and C. The log 2 ratios are plotted in blue and the CBS segmentation values are in red. The vertical blue bar represents the centromere.

FIG. 5 panel A is a photograph of a hematoxylin and eosin (H&E) stained slides as examined by a pathologist who determined the tumor cell containing area (circled). FIG. 5 panel B is a set of data that shows a plurality of a CGH profiles for chromosomes 1, 5, 12 and 20 from undissected tissue, in which subtle CNAs are observed. For each of chromosomes 1, 5, 12, and 20, data in the top portion are obtained from a sample in which tumor cells have been dissected away. For each of chromosomes 1, 5, 12, and 20, data in the bottom portion are obtained from a complete sample. The comparison indicates that inclusion of adjacent non-tumor DNA interferes with obtaining a tumor aCGH signature. Segments in the microdissected samples that were outside of the mean+/−2 SD of all segments were compared to the corresponding regions from the undissected samples to substantiate the observations made in panel B. An example from a single such pairwise comparison is given. The mean of all the BAC log 2 ratio values for a given segment (+/−SD) from the undissected sample is shown next to the same information for the corresponding microdissected sample. For this sample, most of the changes are losses, and all comparisons are statistically significant at p<0.05 (two-sided Mann-Whitney U-test). These changes would not have been detected if the sample had not been microdissected.

FIG. 6 is a set of aCGH profiles showing a comparison of representative BAC and aCGH profiles from each of one cell, 10 cells and 100 cells isolated by laser capture microdissection using L428 Hodgkins lymphoma cells. Chromosomal location (Mb) and log 2 ratio are plotted along the x and y axes, respectively. Replicates of individually-isolated and amplified samples are shown, and exemplary chromosomes 7 and 9 (left and right column, respectively) are displayed. The remainder of the genome showed similar aCGH signals (and noise) and relationships between the treatment groups. Segments indicating gain or loss were evident even in the single cell samples. Statistically significant data were obtained as a function of numbers of cells to the ‘gold standard’ untreated reference.

FIG. 7 is a set of aCGH profiles of an HNSCC tumor assayed independently on each of a 19K BAC and a 244K Agilent array. Sample DNA was derived from frozen (panel A) and FFPE (panel B) sections. BAC aCGH is shown across the top row in both FIG. 7 panel A and FIG. 7 panel B, and Agilent aCGH is shown across the bottom row in both FIG. 7 panel A and FIG. 7 panel B.

FIG. 8 is a set of aCGH profiles of an HNSCC tumor DNA assayed with standard 19K BAC array conditions (top) and modified conditions (bottom) for chromosomes 3 (left) and 5 (right).

FIG. 9 is a set of aCGH profiles of chromosome 9 from a sample of an HNSCC tumor as determined by a 19K BAC array (left) and a 244K Agilent array (right).

FIG. 10 is a drawing showing an apparatus that in various embodiments illustrates methods involved in using two sets of arrays and a single DNA sample to obtain aCGH data. A gasket 1004 is applied to a first slide 1003 having a printed array with, for example, nucleic acid targets which is then loaded by pipette 1005 or other liquid delivery methods with hybridization fluid containing labeled nucleic acid probes. A second slide 1002 having for example a microarray printed with substantially the same or different targets as the first slide 1003 is placed on the gasket 1004 of 1003, sealing the hybridization fluid in place in a location sandwiched between the arrays. The slides (1002, 1003) with the microarrays, held together a clamping device 1001 to prevent evaporation and leakage and maintain the liquid sample during hybridization, are placed into a hybridization chamber. After the hybridization period, the slides are disassembled, and washed to remove un-reacted sample, and the hybridization results, i.e., amount of labeled target molecules hybridized to each array member, are scanned in a laser scanner to obtain the data.

FIG. 11 is a drawing showing a clamping device with a hinge 1101; a top slide array 1102; a bottom slide array 1103; a gasket 1104; a latch 1105; a top hinge body 1106; a bottom hinge body 1107. The top slide array 1102, bottom slide array 1103 and gasket 1104 are placed in the clamping device such that the hybridization fluid is sealed between the array faces by the gasket 1104 and the top hinge body 1106 is pressed down to engage with the latch 1105 such that the top hinge body 1106 and bottom hinge body 1107 hold the top slide array 1102 and a bottom slide array 1103 in compression of the gasket 1104.

FIG. 12 shows a clamp 1201 for use in the clamping device similar to 1001 in FIG. 10, in which are found: a top slide array 1202; a bottom slide array 1203; and a gasket 1204. The top slide array 1202, bottom slide array 1203 and gasket 1204 are placed together such that the hybridization fluid is sealed between the array faces by the gasket 1204 and a metal clamp 1201 is placed over each end of the stacked slide arrays such that the metal clamps 1201 hold the top slide array 1202 and a bottom slide array 1203 in compression of the gasket 1204.

FIG. 13 shows an electromagnet embodiment of the clamping device having; a ferrous plate 1301; a top slide array 1302; a bottom slide array 1303; a gasket 1304; and an electromagnet 1305. The top slide array 1302, bottom slide array 1303 and gasket 1304 are placed together such that the hybridization fluid is sealed between the array faces by the gasket 1304 and the ferrous plate 1301 is pulled down towards the electromagnet 1305 such that the top slide array 1302 and a bottom slide array 1303 compress the gasket 1304

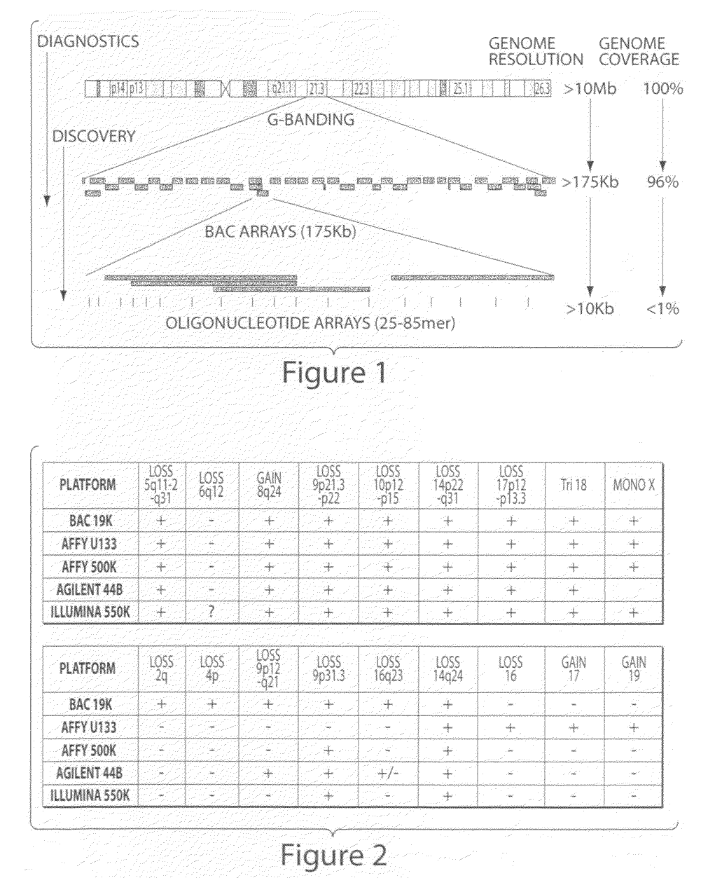

### DETAILED DESCRIPTION

A reliable dual hybridization method and device utilizing both Bacterial Artificial Chromosome (BAC) based and oligonucleotide arrays is needed for molecular characterization of cancer, for cross platform validation, and to identify BAC clones for utilization in Fluorescent In Situ Hybridization (FISH) on Tissue MicroArray (TMA) studies designed with cohorts of patients selected by virtue of their stage and outcome status. Such a method would further advance the discovery and characterization of novel cancer biomarkers.

A technology that combines each of the BAC and the oligonucleotide platforms into a single aCGH reaction combines the strengths of each platform into one analysis. The term, “aCGH” as used herein has the generally understood definition of “array comparative hybridization.” The methods and devices of the invention involve describe a single assay, with simultaneous co-hybridization of labeled nucleic acid molecules on the two microarray platforms. This method accurately compares these platforms under the same conditions, providing simultaneous validation of the results obtained from the two platforms in a single assay, and minimization and preservation of sample material required for analysis.

BAC based array CGH has been found to have the highest signal to noise ratio, and lowest coefficient of variance in a recent study comparing among BAC CGH technologies from several commercial sources. (Hester et al., ABRF Annual Meeting, Tampa Fla., Mar. 31-Apr. 4. 2007). Functional resolution for these platforms was found to be essentially equivalent to high density or tiling BAC arrays for detecting single copy alterations. (Coe et al., Genomics, 647-653, 2007). The methods of aCGH using archival samples from formalin fixed paraffin embedded (FFPE) derived material have been performed with variable results obtained using platforms not requiring complexity reduction such as BAC or Agilent CGH arrays. Agilent Technologies and BAC aCGH both utilize total genomic DNA. Affymetrix and Illumina generate complexity reductions of the test sample prior to aCGH analysis. (Ibid.)

The Bioscore assay assesses quality of FFPE DNA prior to aCGH studies, using archival source DNA. Comparing matched samples and measuring their signal to noise shows that BAC aCGH arrays provide significantly higher signal to noise values. The signal to noise declines in the transition from frozen tissue source DNA to FFPE tissue source DNA to whole genome amplified (WGA) DNA samples. This decline in signal to noise is accompanied by, on average, a large number of CBS (Circular Binary Segmentation) segments for FFPE derived DNA than for frozen derived DNA. (Olshen et al., Biostatistics, 5: 557-572, 2004). Ultimately, identifying divergent subpopulations that exist within a tumor through microdissection or focused sampling provides a more comprehensive and accurate analysis that may only be possible by analysis of archival DNA sources.

An embodiment of the invention herein provides a device for performing simultaneous dual array comparative genomic hybridizations using a single aqueous sample of nucleic acid, the device including: a first substrate array having a first array printed surface and a first array non-printed surface, such that the first array includes a first plurality of sequence targets, each target immobilized to a discrete and known spot on the first array printed surface; a gasket adjacent to and in contact with the first array printed surface, such that the gasket forms a liquid-tight seal with the first array printed surface; a second substrate array having a second array printed surface and a second array non-printed surface, in which the second array includes a second plurality of sequence targets, each target immobilized to a discrete and known spot on the second array printed surface, such that the second array printed surface contacts the gasket and the gasket forms a liquid-tight seal with the second array printed surface; and a clamping device, in which the clamping device has a cooperative relationship with the first array non-printed surface and the second array non-printed surface, such that the sample is contracted to the first substrate and the second substrate, to perform simultaneous dual array.

In an embodiment of the device, the clamping device includes an epoxy layer between the gasket and each of the first array printed surface and the second array printed surface. In a related embodiment of the device, the clamping device is a chamber with two rails. The space between the rails is narrower than the uncompressed height of the two slides with the gasket between them. The slides with printed arrays and a gasket holding a liquid sample sandwiched between them are inserted into the rails or slots so that the rail on each side of the slide sandwich presses the two slides against the gasket.

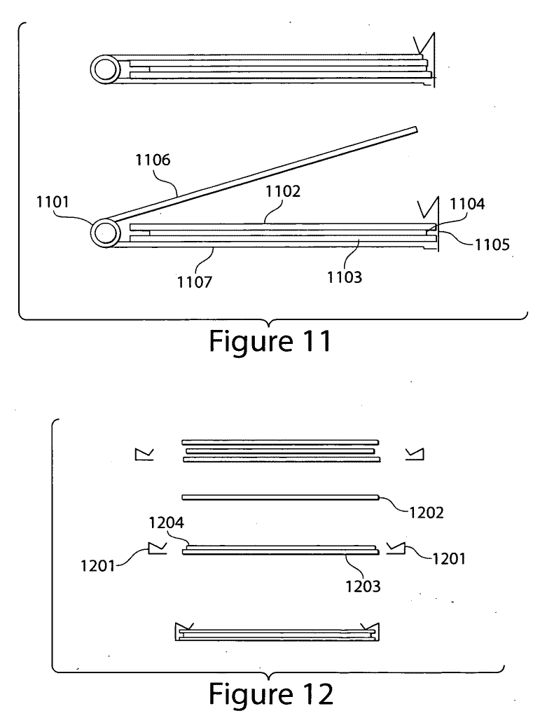

In a related embodiment of the device, the clamping device includes at least one elastic band. In another related embodiment of the device, the clamping device includes a plurality of straps. In yet another embodiment of the invention herein as shown in FIG. 11 the clamping device includes at least one hinge attached to each of the first substrate array and the second substrate array, such that the first substrate array and the second substrate array are rotationally moveable by varying the angle of opening of the hinge.

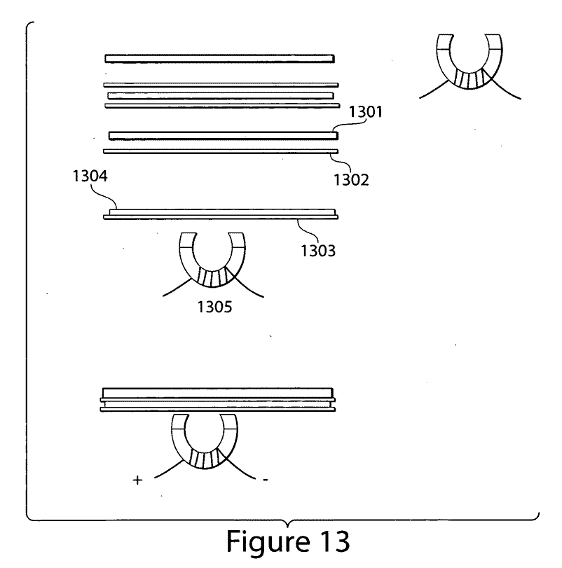

In certain embodiments of the device, the clamping device includes a vacuum seal. In other embodiments of the device, the clamping device includes electromagnets such as the embodiment shown in FIG. 13. Alternatively in another embodiment, the clamping device includes two or more frames in which at least one frame is magnetic. In another embodiment of the device the clamping device includes a cam. In certain embodiments of the device, the clamping device includes a coil spring. In another embodiment of the device, the clamping device includes a leaf spring.

In another embodiment of the device, the clamping device includes pressure, for example, pneumatic pressure or hydraulic pressure.

In certain embodiments of the device, the clamping device includes a wedge. In another embodiment of the device, the clamping device includes a toggle. In another embodiment of the device such as that shown in FIG. 12, the clamping device includes clips. In various embodiments of the device, the clips are fabricated from deformable metal, plastic, wood, fiberglass or other materials having a spring or memory characteristic wherein the material returns to a pre-deformation configuration when a deforming force is removed. The clips are placed on the slide and gasket sandwich so that they press against the surface of the slide distal to the printed array and hold the slides in compression against the gasket. The compression of the gasket between the slides seals the liquid sample between the slides and prevents leakage of the sample.

In certain embodiments of the, the immobilized sequence targets include at least one polynucleotide selected from the group consisting of: genomic DNA, mitochondrial DNA, cDNA, RNA, mRNA, tRNA, rRNA, siRNA, RNAi, and dsRNA.

In an embodiment of the device, the gasket includes deformable material, for example, the deformable material is at least one material selected from the group consisting of rubber and plastic. In certain embodiments of the device, the rubber is selected from the group of natural and synthetic. In another embodiment of the device, the rubber further includes at least one material selected from the group consisting of latex, silicone, and liquid silicone. In another embodiment of the device, the plastic is at least one polymer selected from the group consisting of polyurethane, polyurethane foam, polyethylene, polypropylene, polybutylene, polystyrene, and polymethylpentene. In yet another embodiment of the device, the plastic polymer further includes at least one atom selected from the group consisting of oxygen, chlorine, fluorine, nitrogen, silicon, phosphorous, and sulfur.

In an embodiment of the device, the first array sequence targets and second array sequence targets are substantially the same. In another embodiment of the device, the first array sequence targets and second array sequence targets are different. In another embodiment of the device, the resolution ability of the first array is substantially the same as that of the second array. In yet another embodiment of the device, the resolution ability of the first array is different from that of the second array. In another embodiment of the device, the resolution ability of the first array is equal to that of the second array.

In certain embodiments of the device, each sequence of the sequence targets is printed in a plurality of replicates on each of the first array and the second array. In a related embodiment of the device, the plurality of replicates includes different amounts of at least one immobilized sequence target. In another embodiment of the device, the immobilized sequence targets are covalently bound to the printed surfaces.

In certain embodiments of the device, at least one spot is intended as a positive control. In another embodiment the device, at least one spot is intended as a negative control. In a related embodiment of the device, the negative control is for example, a non-human genome, for example, is a non-primate genome, for example, is a non-vertebrate genome, for example, is a non-mammalian genome, or even a non-animal genome. An embodiment of the device includes the negative control that is a prokaryotic genome, or a viral genome, or a zebra fish or a plant genome.

Also provided herein is a method for performing simultaneous dual array comparative genomic hybridizations with a single sample, the method including: co-hybridizing simultaneously a mixture of a labeled test sample and a differently labeled reference sample to a first array of sequence targets on a first substrate surface and a second array of sequence targets on a second substrate surface, such that the co-hybridizing includes contacting an aliquot of the mixture to both of the first array and second array simultaneously, in which the first array substrate surface and the second array substrate surface are physically discrete, and such that the first array is a first plurality of sequence targets, each target immobilized to a discrete and known spot on the first substrate surface to form the first array of sequence targets, and the second array is a second plurality of sequence targets, each target immobilized to a discrete and known spot on the second substrate surface to form the second array of sequence targets.

in a related embodiment of the method, prior to co-hybridizing, the method further includes labeling the test sample, and labeling the reference sample, such that the test sample and the reference sample are differently labeled.

In another related embodiment, the method further includes detecting co-hybridization of each of the labeled test sample and the differently labeled reference sample to each of the first and second arrays. In another related embodiment of the method, detecting is performed by a laser scanner.

In yet another related embodiment, the method further includes comparing an intensity of a signal from the labeled test sample hybridized with the differently labeled reference sample on the sequence targets. In another related embodiment, the method further includes comparing a signal ratio of each spotted element of the sequence targets derived from the first array with each spotted element of the sequence targets derived from the second array to determine, define, and evaluate relative copy numbers in the labeled sample that are bounds to the sequence targets of each of the first and second arrays.

In an embodiment of the method, the sequence targets are at least one polynucleotide selected from the group consisting of: genomic DNA, mitochondrial DNA, cDNA, RNA, mRNA, tRNA, rRNA, siRNA, RNAi, and dsRNA. In another embodiment of the method, each of the test sample and the reference sample is at least one polynucleotide selected from the group consisting of: genomic DNA, mitochondrial DNA, cDNA, RNA, mRNA, tRNA, rRNA, siRNA, RNAi, and dsRNA.

In certain embodiments of the method, the test sample is obtained from at least one biological specimen selected from the group of specimens consisting of: human tissue; embryo tissue; biopsy; blood; urine; cerebral spinal fluid; amniotic fluid; chorionic villus; and embryonic cell or embryo tissue.

In another embodiment of the method, the first array sequence targets and the second array sequence targets are substantially the same. In another embodiment of the method, the first array sequence targets and the second array sequence targets are different. In another embodiment of the method, the first array resolution ability and the second array resolution ability are substantially the same. In another embodiment of the method, the first array resolution ability and the second array resolution ability are different.

Another embodiment of the invention provided herein is a device for performing simultaneous dual binding assays using a single sample, the device including: a first substrate array having a printed surface and a non-printed surface, such that the first array includes a first plurality of sequence targets, each target immobilized to a discrete and known spot on the first array printed surface; a gasket adjacent to and in contact with the first array printed surface, such that the gasket forms a liquid-tight seal with the first array printed surface; a second substrate array having a printed surface and a non-printed surface, in which the second array includes a second plurality of sequence targets, each target immobilized to a discrete and known spot on the second array printed surface, in which the second printed surface contacts the gasket and the gasket forms a liquid-tight seal with the second array printed surface; and a clamping device, such that the clamping device has a cooperative relationship with the first array non-printed surface and the second array non-printed surface. In an embodiment of the invention, the sequence targets are polypeptides.

Another aspect of the invention herein provides a method for performing simultaneous dual array binding assays with a single sample, the method including: co-hybridizing simultaneously a mixture of a labeled test sample and a differently labeled reference sample to a first array of sequence targets on a first substrate surface and a second array of sequence targets on a second substrate surface, such that the co-hybridizing includes contacting an aliquot of the mixture to both of the first array and second array simultaneously, in which contacting is under conditions that promote binding of components of the mixture to each array, such that the first array substrate surface and the second array substrate surface are physically discrete, and the first array is a first plurality of sequence targets, each target immobilized to a discrete and known spot on the first substrate surface to form the first array of sequence targets, and the second array is a second plurality of sequence targets, each target immobilized to a discrete and known spot on the second substrate surface to form the second array of sequence targets.

In an embodiment of the method, the sequence targets are polypeptides, including synthetic sequences, designed sequences, naturally occurring proteins or proteins thereof.

An embodiment of the method herein includes the following steps: labeling DNA derived from a single cell or disease population with a single fluorescent label; hybridizing said labeled DNA sample with a differentially labeled reference DNA sample to a pair of microarrays containing different target nucleic acids (e.g. one Empire Genomics BAC array, one Agilent oligonucleotide array); comparing the intensities of the signals from the labeled DNA genome hybridized with the reference genome on the target nucleic acids; comparing the signal ratio of each element of the target genome derived from each microarray platform with one another to determine, define and validate the relative copy numbers of nucleic acid sequences in said DNA sample population that are bound to such target elements.

Standard laboratory equipment can be employed with the protocols, reagents and analysis tools developed specifically for the dual platform microarray assay, facilitating adoption and utilization across laboratories.

An embodiment of the device for carrying out dual array hybridization includes each of a BAC micro array and an oligonucleotide printed microarray separated by a waterproof gasket that is in contact with each printed microarray surface, and the device contains the sample and leakage is prevented by the gasket. This device of printed microarrays, sample and gasket is placed in a chamber in which the microarrays are held in contact with the gasket by a clamping device. The clamping device may be mechanical, electromagnetic, hydraulic or chemical (i.e. an epoxy or thermosetting epoxide polymer that polymerizes and crosslinks when mixed with a catalysing agent). The device is placed in an oven (incubator) for hybridization resulting.

The Empire Genomics BAC arrays utilize RPCI-11 BAC clones that have served as the intermediate templates for the International Human Genome Sequencing Consortium. (Cheung, V. G. et al. Nature, 409: 953-958, 2001; Nowak et al., Current Protocols in Human Genetics, 1-34, 2005). In general herein, exemplary samples, clones, and sequences are chosen from those of human origin unless otherwise indicated, and alternative embodiments are within the scope of the invention. The sequences or clones are obtained or replicated from a clone of human DNA, or are synthesized according to a known sequence in a database by the methods herein.

The DNA from each of the clones is prepared by ligation-mediated PCR (LM-PCR), and products are deposited on glass slides as targets for aCGH. The LM-PCR products that are generated to represent the BACs are of a size and complexity that increases hybridization signal and therefore accuracy in identifying true copy number changes (Hester et al. Snijders et al., Nat. Genet., 29: 263-264, 2001). BAC arrays detect segmental amplification of whole chromosome arms, terminal deletions, and discrete, low magnitude copy number gains and losses. Using BAC aCGH, genome wide scans of DNA can be obtained from difficult samples that are often heterogeneous, harbor varying degrees of aneuploidy, or are derived from FFPE archive material, (i.e. tumor samples stored in pathology archives of formalin-fixed paraffin embedded material).

The methods and devices herein use a whole human genome oligonucleotide microarray as a complementary tool to a BAC aCGH array. The oligonucleotide arrays contain 60mer targets that are located on slides at densities of 244,000 features, or spots or elements, per slide or chip, this number of features providing an overall genomic resolution of about 10 kb. Due to their small target size however, oligonucleotide arrays suffer from poorer signal to noise ratios that often results in a significant number of false-positive outliers (Barrett et al., Proc. Natl. Acad. Sci. U.S.A, 101: 17770, 2004; Brennan et al., Cancer Res, 64: 4744-4748, 2004). Typically 4-6 adjacent oligonucleotides, i.e., oligonucleotides encoding sequences that are found in vivo at adjacent locations, are necessary for a reliable interpretation, thus identification of regions of copy number aberrations (CNA) includes use of statistical tools and moving average algorithms. Computational smoothing of oligonucleotide data however, reduces the spatial resolution and can be difficult to standardize over large data sets. Repeat hybridizations are often recommended to resolve false-positive outliers. Results obtained using the small oligonucleotide target size also has in the past had limited success when used with degraded DNA or DNA prepared from FFPE tissue.

The methods provided herein use a single assay for simultaneous co-hybridization of labeled nucleic acid molecules so that hybridization of a single fluid sample, generally an aqueous solution, occurs to each of two or more arrays, with the device herein. This method provides the user with simultaneous replication of the assay and/or validation of data during a single reaction time with a single sample, using for example two different types of microarrays, one on each of two slides, or two or more replicates of the same type of microarrays. For diagnostic applications, this approach makes possible the simultaneous comparison of patient samples on two microarray platforms containing substantially the same or different target nucleic acids or types of nucleic acids, allowing for concurrent validation of the microarray results in a single assay thus minimizing an amount of sample material required for analysis, as well as minimizing variability in buffers, temperatures, pH, and in time and cost of reagents. This methodology provides greater statistical power in experiments because of the amounts of data generated.

The 19K BAC array (having about 19,000 clones) and the Agilent 244K human CGH array (having about 244,000 clones), similar to the BAC array, each detect large copy number changes; the latter having the theoretical benefit of improved potential resolution. In addition, the total possible numbers and locations of breakpoints associated with chromosomal aberrations are potentially better resolved due to the increased numbers of elements contained on the array. The Agilent array is manufactured on a glass slide and with dimensions that are compatible and complementary with the 19K BAC array for the dual hybridization device and method herein.

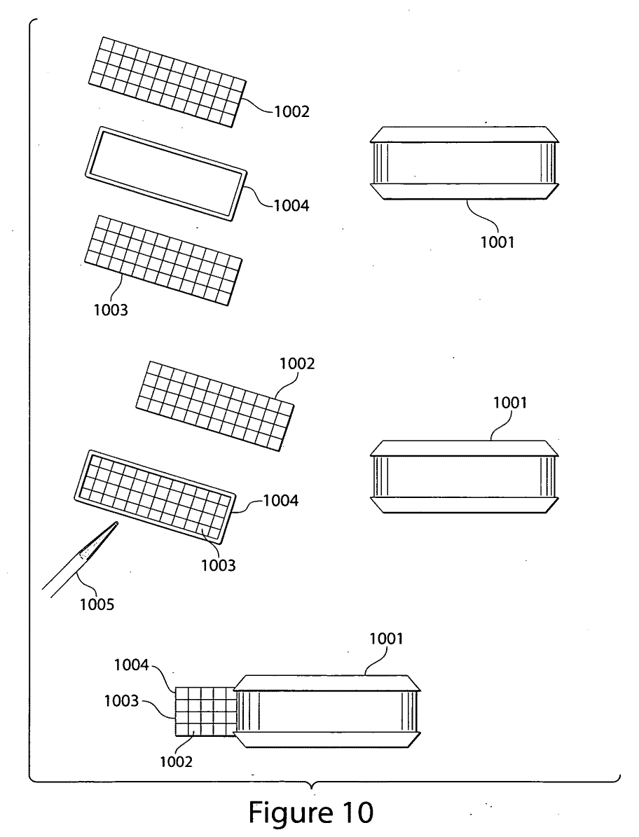

An overview of the dual hybridization methods or method herein is as follows. Labeled DNA probes are prepared, for example, using the BioArray CGH genomic labeling kit v4.0 (Enzo Life Sciences), and any standard labeling procedure is suitable. Simultaneous hybridization of a sample to two microarrays is carried out in a rotating oven (see FIG. 10). Microarrays are washed and scanned using a dual laser scanner or other system appropriate to the type of label used. Data is obtained and analyzed to detect and define the genetic content of the sample. It is envisioned herein that the dual system is not limited to use with any particular downstream analysis method such as colorimetric or fluorescent labeling and laser scanning, rather any suitable assay such as protein binding of small molecules may be measured by appropriate labels and detection systems.

To obtain optimal results from interactions of the molecules present in the assay liquid, hybridization-probe solution circulates on both or alternately on either of the arrayed surfaces without interference by leaking, drying or creating air bubbles. When adjoining two slides in a dual-hybridization device a gasket is used, preferably a gasket made of an inert material, having ability to compress slightly to insure a tight seal around the periphery of the arrayed area, and having a height dimension that promotes consistent solution movement during hybridization. Several gasket types, i.e. rubber, liquid rubber or silicone, address these criteria, and are commercially available with characteristics having tight specifications for containment of fluids. A chamber holds the two arrayed slides together, and preferably is constructed for ease of use, for example, with methods of applying an amount of pressure appropriate to prevent leakage or slide breakage, and has a size suitable to contain the arrays and samples, and suitable to fit in an appropriate rotisserie. A variety of different suitable clamping devices and chambers are shown in FIGS. 10-13 herein.

The chamber and gasket device is tested using the helium leak test. This test measures in parts per million (ppm) the amount of gas, moisture and liquid leakage in a system. This standard test in the medical device and semiconductor fields is cost effective and sufficient for the criteria of this technology application.

Protocol, reagents and materials are designed to be used in the dual hybridization process to obtain aCGH results for two microarray aCGH slides processed simultaneously in one environment.

The process herein has been optimized using data obtained from varying several key components of the protocol. The optimization included measuring and comparing known copy number changes, calculating reproducibility using four replicas for each hybridization, and calculating the coefficients of variation (CV) both within and between BAC arrays and Agilent oligonucleotide arrays. The optimization process also includes calculating and comparing the number of segments using the Circular Binary Segmentation (CBS) algorithm.

Examples of materials and methods for a variety array types include the following. For a human 19K BAC array DNA printing solutions were prepared from sequence connected RPCI-1 1 BAC by ligation-mediated PCR as described in (Nowak et al., Current Protocols in Human Genetics, 1-34, 2005; Snijders et al., Nat. Genet., 29: 263-264, 2001; Nowak et al., Cancer Genet. Cytogenet., 161: 36-50, 2005). The minimal tiling RPCI BAC array includes about 19,000 BAC clones that were chosen on the basis of the following criteria: sequence tagged site (STS) content, paired BAC end-sequence and association with heritable disorders and cancer.

The backbone of the array consists of 4600 BAC clones that were directly mapped to specific, single chromosomal positions by fluorescent in situ hybridization (FISH; Cheung et al., Nature, 409: 953-958, 2001). Each clone is printed in duplicate on amino-silanated glass slides (Schott Nexterion typeA+) using a MicroGrid II TAS arrayer (Genomic Solutions, Inc.). The resulting BAC DNA products, i.e., substrate slides printed with arrays, have elements that are spots that are about 80 pm in diameter, with center to center spacing of about 150 pm, creating an array of about 39,000 elements. The printed slides are dried overnight and are UV-crosslinked (350 mJ) in a Stratalinker 2400 (Stratagene) immediately before hybridization.

Agilent 244K human oligonucleotide CGH arrays contain about 236,000 probes designed to encompass coding and noncoding sequences of the human genome. Probe coverage spans coding and noncoding regions, including known genes, promoters, miRNAs, and telomeric regions. This array is composed of 60-mer oligonucleotides having an average spatial resolution of 6.4 kB. The content is sourced from UCSC hg17 human genome (NCBI build 35, May 2004).

Probes were prepared as follows: the labeling reagents and sample requirements were optimized to process both of the two arrays simultaneously. A minimum expectation was that the methods provided herein would satisfy a purpose, i.e., would decrease the reagent and sample requirements by at least about 30%, as the dual reactions would occur simultaneously and in about the same surface area that two arrays require when each is run individually.

Using the CGH Labeling Kit for Oligo Arrays as a starting point, variations in the protocol and reaction conditions were explored to improve labeling efficiency, yield and probe incorporation. The resulting probe was observed to be highly reactive both to the large BAC targets and to the smaller oligonucleotide targets.

Hybridization was carried out as follows. Temperatures, buffers and blocking agents were adjusted to obtain results similar to those obtained when the platforms are run individually using each of the suggested protocols. The conditions chosen were standard, i.e., use the same logic and methodology as in the 2007 ABRF MARG study (Association of BioMolecular Resources MicroAssay Research Group) to determine comparability and reproducibility of the results between the two slide types, with a series of cell lines characterized at the passages used for DNA preparation of the samples.

Cells were characterized by Giemsa karyotyping, SKY (Spectral Karyotyping) and FISH (Fluorescent In Situ Hybridization). The 19K BAC and 244K Agilent arrays were hybridized simultaneously in a buffer formulated to optimize hybridization of BAC ligation PCR product targets (400-700 bp) and long oligonucleotides, and the device was incubated in a rotating hybridization oven at an appropriate temperature such as in the range of about 55 to about 65° C. for a suitable time such as about 16 hr to about 32 hr.

In one embodiment of the device the two arrays were sandwiched together using a gasketed chamber of various inert materials as described herein, clamped, and positioned in a cassette. In one embodiment the gasket is supplied for example by REDCO (Rubber Engineering and Development Company, Carson City, Nev.) that specializes in producing rubber molded materials, dye cut gaskets for custom sealers and gaskets for many applications. Several types of gaskets, for example from REDCO, are suitable for sealing the chamber.

Post hybridization methods include well-known wash conditions and reagents that were adjusted to reduce background, lower artifact signal (background noise) and preserve signal intensity while maintaining a high throughput requirement.

For image and data analysis, the hybridized BAC slides were scanned using for example a GenePix 4200AL Scanner (Molecular Devices) to generate high-resolution (5 pm) images for DNA separately labeled with each of two fluorescent or colorimetric dyes, for example both Cy3 (to label the test sample) and Cy5 (to label the reference control) channels. Image analysis was performed using the ImaGene (version 7.5.0) software from BioDiscovery, Inc. The log 2 test/control ratios were normalized using a sub-grid loess correction. Mapping information was added to the resulting log 2 test/control values.

The map data for each BAC is well known and is available in a computer readable format as public information on databases well known to those of skill in the human genome. (See for example the database at http://genome.ucsc.edu.) BACs in regions of segmental duplication or large-scale variation (LSV) were identified for further study. The hybridized Agilent 244K slides are scanned using a DNA Microarray Scanner (Agilent Technologies) to also generate high-resolution (5 pm) images for sample DNA labeled with, for example, Cy3 (test) and Cy5 (control) channels. Image analysis on the Agilent 244K arrays was performed using the Feature Extraction version 9.1 (Agilent Technologies; CGH-v4_{—}91) protocol. The results were imported into CGH Analytics version 3.4.27 (Agilent Technologies) for aberration detection and visualization. Scanning of slides and determining appropriate laser and PMT settings for optimal image acquisition were automated.

Validation of dual hybridization aCGH results with independent BAC and Agilent CGH was performed on each of a number of well characterized DNA samples derived from tumor cell lines, as shown in Examples herein.

The invention having now been fully described, it is further illustrated by the following examples and claims, which are illustrative and are not meant to be further limiting. Those skilled in the art will recognize or be able to ascertain using no more than routine experimentation, numerous equivalents to the specific procedures described herein. Such equivalents are within the scope of various embodiments of the present invention and claims. The contents of all references, including issued patents and published patent applications cited throughout this application, are hereby incorporated by reference.

### EXAMPLES

### Example 1

### Cell Line Characterization

The tumor cell lines SKBR3, FADU, A253, HCT116 and OPM2 were characterized for cytogenetic rearrangements. Cells from each line were obtained from the same passage to prepare DNA, and characterizations by G banding and SKY were preformed as previously described (Cowell, et al., Cancer Genet. Cytogenet., 163:23-29, 2005).

### Example 2

### Analytical Methods

For statistical analysis, BAC and Agilent arrays were pre-processed as described in Nowak et al. (Nowak et al., Genet. Med., 9: 585-595, 2007). The median adjusted log ratio (ALR) log 2 tumor/control value was calculated for hybridization data obtained for each BAC and/or oligo by obtaining the mean of the replicate (using data which passed quality control) processed log 2 ratios for each BAC/oligo, and then subtracting the median log 2 ratio calculated from all of the autosomal BAC/oligos.

Regions with common copy number means were identified by segmenting the genome using DNAcopy software (Olshen et al., Biostatistics, 5: 557-572, 2004). The procedure measures the amount of DNA for each labeled sample at each site, and the software identifies whether the amount of DNA bound is substantially the same as that for sites having neighboring sequences, i.e., located adjacent in vivo of the genome of the organism being tested. If the amounts detected between neighboring sequences were observed to be different, then the software breaks the appropriate sequences into separate DNA segments. The median absolute deviations (MAD) were calculated for the BAC/oligos on each segment, and the median of the MAD score (MMAD) was taken across all segments.

Each BAC/oligo was assigned a fitted log 2 ratio value equal to the median of the segment for which the oligo was determined to be a member. All BACs with an additive log ratio (ALR) median absolute deviation (MAD value) greater than five were identified as outliers, and the fitted log 2 ratios for those BAC/oligos were set to the original log 2 ratio values. Missing values were replaced by the average fitted log 2 T/C values (test/control ratios) of the nearest non-missing flanking BAC/oligos. The median absolute deviation of the fitted values from the ALR values were calculated and were used to estimate the variability of the ALR values within each sample. The signal to noise for each array dataset was computed by taking a median of the X chromosome fitted log 2 T/C divided by the MAD for that dataset.

The array assays (i.e., a BAC array, an Agilent Array, and a Dual Slide Array) were conducted on five technical replicate samples for each of the five cell lines (i.e., a total of 3×5×5=75 arrays were assayed and 75 resulting datasets were generated). A recovery oriented computing (ROC) based calculation constituted the primary analysis of the data generated for these examples. The cell lines were well characterized by several conventional methods (e.g., by G Banding, SKY and FISH) so that regions containing known copy number aberrations and regions lacking such changes were identified for each cell line. Array based estimates of copy number aberration were obtained by applying cut-off rules to the fitted log 2 ratios (i.e., aberration calls were applied segment-wise).

ROC curves were generated by considering a broad range of cut-off values for copy number loss and gain. Six sets of ROC curves were generated for each technical replicate corresponding to determinations made using the BAC array, the Agilent array, only the BAC array of the dual array, only the Agilent array of dual array, an intersection rule for both the Agilent and BAC (over the four dimensional space of cut-offs for both platforms), and a union rule for both the Agilent and BAC arrays. For the intersection rule, a segment is considered aberrant if the data in both platforms are consistent and indicate that the segment is aberrant. For the union rule, a segment is determined to be aberrant if aberrant results are obtained in either of the two platforms. For this joint analysis genomic regions were segmented according to boundaries obtained from applying the CBS algorithm (i.e., DNAcopy software) to the four genomic profiles (i.e., BAC, Agilent, BAC from Dual Chip, and Agilent from Dual Chip profiles). These segments were further segmented to identify regions that were included (approximately) in both platforms and those that were included in only one of the two platforms. The union and intersection rule ROC curves were generated for those segments that were found to contain deletions or to be deleted. A secondary analysis was further conducted for segments that were determined to be located in non-overlapping regions.

Other secondary analyses included comparative studies of the level of each of noise, and signal to noise, observed herein to be significant in more than one platform. Random coefficients models were implemented with respect to cell line and type of labeling, and with respect to array variability.

Validation of CNAs by FISH was performed on the cell line nuclei for concordance with aCGH data using RPCI-11 BAC clones as described (Cowell, J. K., et al. Cancer Genet. Cytogenet., 163:23-29, 2005).

### Example 3

### BAC Assay

The goal of the 2007 ABRF MARG project was to assess the ability of current technologies to detect chromosomal aberrations. This assessment selected five CGH platforms to compare, with a sample a test genome which is the promyelocytic leukemia cell line HL60 having a variety of known genetic material gains and losses, and analysis software that would maximize the resolution of each platform. The five platforms for detecting chromosomal aberrations were: Agilent CGH 44K Microarray, Illumina HumanHap 550 Beadchip, Affymetrix GeneChip® Human Mapping 500K Array Set, Roswell Park Cancer Institute developed human 19K BAC array, and the Affymetrix Human Genome U133 Plus 2.0 gene expression array.

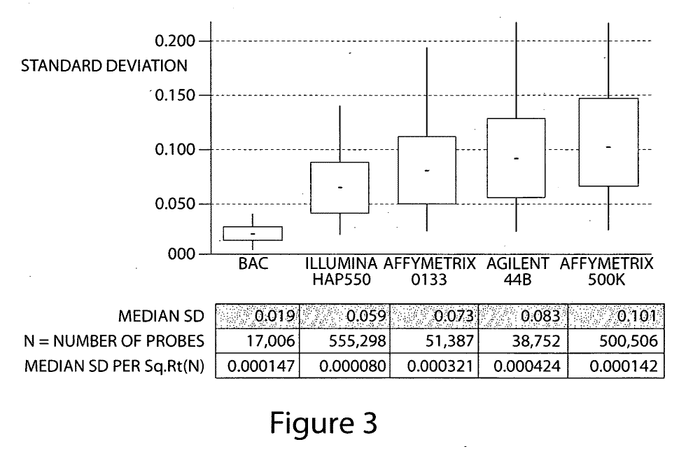

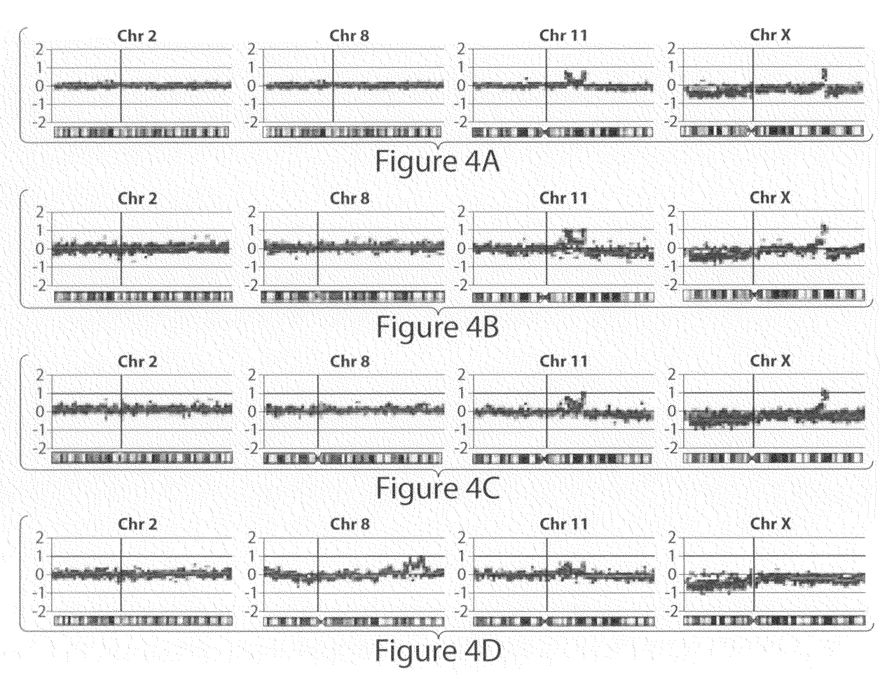

It was observed herein that the platforms were able to detect eight of the nine previously published copy number changes in the HL60 DNA (FIG. 2). Large chromosomal deletions were found by all platforms, including microarrays designed for gene expression studies. Raw ratio values obtained indicated that BAC arrays have better repeatability of HL60/reference DNA ratio than high density oligonucleotide platforms (FIG. 3). However, most platforms were observed to have comparable variation rates, using criteria in which data were normalized as a function of the number of probes.

The data herein show that the BAC array CGH platform performed as well or better than the other array CGH platforms in detecting known and novel CNAs, and showed the best reproducibility.

The strengths of BAC arrays and long oligonucleotide arrays on archival sources of DNA, as well as microdissected sources from both fresh/frozen tumors and FFPE samples were further explored as shown herein.

### Example 4

### Comparison of BAC and Oligonucleotide aCGH Technologies on Frozen and FFPE Tumor Samples

High resolution BAC 19K Minimal Tiling Arrays and Agilent oligonucleotide CGH platforms were compared using DNA isolated from a series of HNSCC (head and neck squamous cell carcinoma) frozen tissue samples and matched multiple FFPE blocks. Ovarian cancer FFPE samples (adenocarcinoma and neuroendocrine tumors), and a subset of the HNSCC cases WGA (Bioscore) were utilized to further determine the effect of DNA quality for aCGH studies. The analysis and the information obtained quantified the effect of DNA source on these aCGH platforms by correlating data obtained by a comparison of the types and numbers of arrays as well as DNA sources. Pearson's correlation coefficients of FFPE DNA assessed by Bioscore to the CGH array results on matching frozen samples were calculated. Overall, the Bioscore assay was successful in identifying FFPE samples yielding high quality interpretable CGH results.

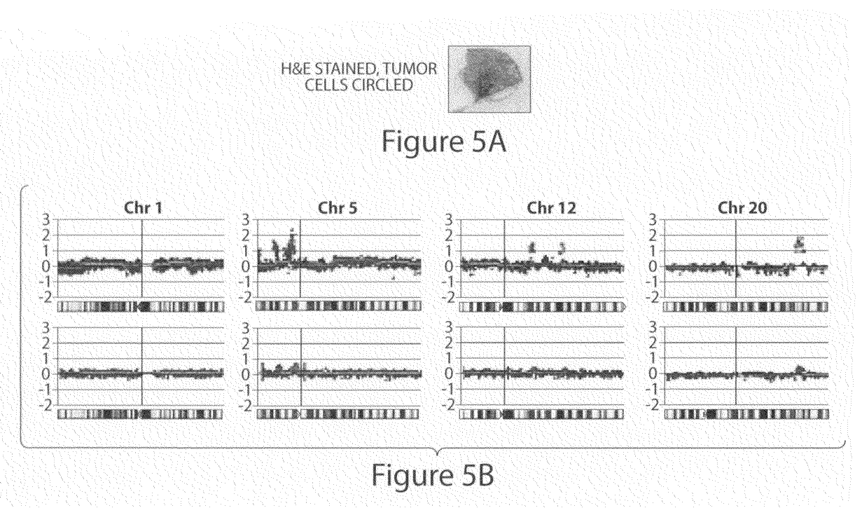

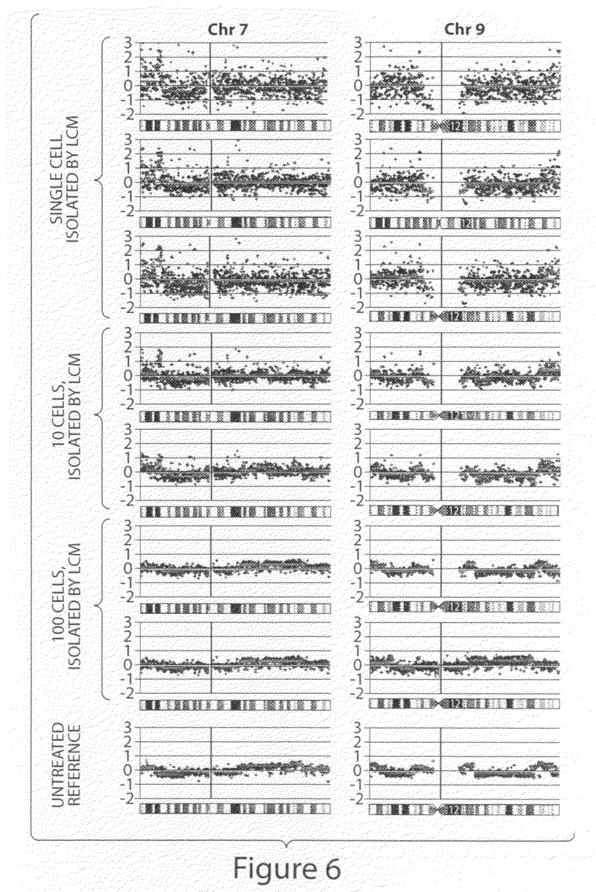

In addition to effects on the results due to the lower quality of DNA from FFPE tumor blocks, tumor heterogeneity was found also to result in a lowered correlation. Even for FFPE and frozen tumor samples that were derived from the same original tumors, the samples were found to differ in the degree of cellularity (i.e., percent of normal cells within a sample), tumor necrosis, and heterogeneity in tumor cell populations. For example, BAC aCGH revealed CNAs in an HNSCC FFPE tumor block that were observed to be absent from the matched frozen sample and from an FFPE block from a different region of the same tumor (FIG. 5).

Amplification of a large region on chromosome 8q encompassing the MYC oncogene was identified, observed in the frozen and the alternate FFPE tissue block, however, this region of the tumor did not show amplification on the X chromosome in this FFPE block. Thus, while the sample of the tumor that was selected for the frozen tumor bank, and the sample that was embedded as one of the two FFPE tumor blocks have substantially the same aCGH profiles (high correlation coefficients), the sample that was selected for the second FFPE block revealed intra-tumor heterogeneity with amplified MYC sequences remaining on band 8g24.1, the normal cellular locus for MYC, in comparison to the other two sections. This result shows that genomic instability of tumors is substantial, and that there is a need to examine either more than one area of a tumor mass or, as shown by the laser confocal microscopy (LCM) studies, the importance of examining the pathologically defined region of the tumor.

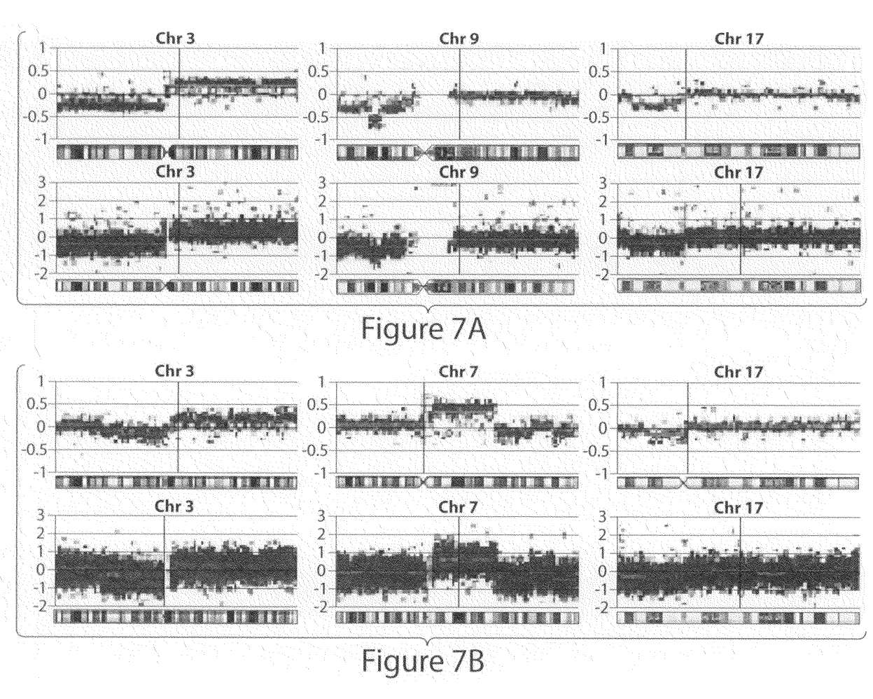

To determine the performance of BAC array CGH on samples of limited cell numbers, BAC array CGH was also performed on samples that were laser capture microdissected from frozen sections and FFPE. Source DNA within and across BAC and Agilent aCGH platforms was also compared (FIG. 7; Nowak et al., Genet. Med., 9: 585-595, 2007). The data obtained using the Agilent platform segmentation was found to most closely match the data obtained from the BAC platform on the frozen tumor samples.

Results with the DNA source were compared among a series of samples for each platform. Signal was estimated by the magnitude of change on the X chromosome, since chromosome X was arranged always to be altered by virtue of the sex mismatched controls. Signal to noise calculations were computed as described (Nowak et al., Genet. Med., 9: 585-595, 2007). The data show that the Agilent aCGH platform yielded many more outlying segments of smaller length than the BAC platform for the same sample.

To compare the data, the same four Mean of Median Absolute Deviation (MMAD) cut-off rule for outliers was implemented for both the BAC and Agilent platforms (Miecznikowski et al., Technical report 06-07: Department of Biostatistics, State University of New York, 1-15, 2006). The larger number of outliers observed herein for data obtained using the Agilent arrays indicates that the platform was either identifying small regions of aberration missed by the BAC platform or that the noise process for the Agilent array was more tail heavy, i.e., susceptible to large spurious outlying values. Data herein showed that, on average, there were more segments determined by characteristic based split (CBS) on the Agilent platform than on the BAC platform, and the segments were smaller in length. For this analysis the CBS algorithm was applied with a setting of alpha=0.025 to data for both platforms. The alpha value is proportional to the probability of spuriously identifying a segment break. Therefore the higher density of the Agilent arrays provided an increased number of spurious segmentations. For the matched frozen or FFPE samples, signal to noise ratio was observed to be significantly higher for the BAC aCGH platform than the Agilent aCGH platform (P-value <0.001 for matched frozen and P-value <0.001 for matched FFPE from a paired t-test).

The signal to noise results were calculated also for each source DNA type for the BAC aCGH platform. The signal to noise values were here found to decrease when comparing frozen tissue samples to FFPE, or to whole genome amplified (WGA) derived DNA samples. This observation was consistent with data herein showing an increase in noise as the DNA quality decreases in FFPE samples.

### Example 5

### Feasibility of Combined BAC and Oligonucleotide Dual Hybridization

Since the BAC platform was observed herein to be robust and had the highest signal to noise, it was reasoned that BAC analysis could tolerate conditions that were optimized for long oligonucleotides. A series of hybridizations were performed using 19K BAC arrays under hybridization conditions that were similar to those for oligonucleotide arrays. Side by side experiments comparing portions of the same labeled probe were performed, with one assay performed in a GeneTac hybridization station using standard conditions for BAC arrays (Ambion Hybridization Buffer 3, 55° C., 16 hr) and the other in a hybridization rotisserie under conditions optimal for long oligonucleotide arrays (Agilent Hybridization buffer, 65° C., 16 hr).

For labeling DNA, 1 μg of each of normal reference genomic DNA and HNSCC sample genomic DNA ( ) was individually fluorescently labeled using the CGH Labeling Kit for Oligo Arrays (Enzo Life Sciences). A beta test with Enzo validated that the labeling kit for oligo arrays produced aCGH results on BAC arrays that were comparable to the results obtained when labeling DNA was performed with kits specific for BAC arrays. Initially, the DNA was denatured in the presence of the random primer at 99° C. for 10 minutes in a thermalcycler, and then quickly cooled to 4° C. The tubes were transferred to ice and labeling was performed with the addition of dNTP-cyanine 3 mix (or dNTP-cyanine 5) and Klenow. Incubation was performed for 4 hours at 37° C. in a thermalcycler. The unincorporated nucleotides were removed using a QIAquick PCR purification column (Qiagen) and the labeled probe was eluted with 2×25 μl washes. The test and reference probes were combined with 100 μg human Cot-1 DNA (Invitrogen) and precipitated for one hour with sodium acetate and ethanol.

A standard hybridization was performed as follows. The probes were pelleted, resuspended in 110 μl SlideHyb Buffer #3 (Ambion) containing 5 μl of 100 μg/μl yeast tRNA (Invitrogen), heated to 95° C. for 5 minutes, then incubated at 37° C. for 30 minutes. The probe was loaded to the 19K BAC array and hybridized 16 hours at 55° C. in a GeneTAC hybridization station.

A modified hybridization was performed as follows. The probes were pelleted, resuspended in 500 pl 2× Hybridization Buffer (Agilent) containing 5 μl of 100 μg/μl yeast tRNA (Invitrogen), heated to 95° C. for 5 minutes, then incubated at 37° C. for 30 minutes. The probe was loaded to the 19K BAC array, sandwiched with a gasketed slide and hybridized 16 hours at 65° C. in a rotisserie hybridization oven (Agilent) at 20 RPM.

Washing and scanning were performed as follows. After hybridization, the slides were washed with decreasing concentrations of SSC and SDS, followed by a two second ethanol dip. The hybridized BAC arrays were scanned using a GenePix 4200AL Scanner (Molecular Devices) to generate high-resolution (5 pm) images for both Cy3 (test) and Cy5 (control) channels. Image analysis was performed using the ImaGene (version 7.5.0) software from BioDiscovery, Inc. The log₂ test/control ratios were normalized using a sub-grid loess correction. Mapping information was added to the resulting log₂ test/control values. The mapping data for each BAC was found by querying the human genome sequence at http://genome.ucsc.edu, and BACs in regions of segmental duplication or large scale variation (LSV) were identified (Sharp et al., Am. J. Hum. Genet, 77: 78-88, 2005; Tuzun et al., Nat. Genet., 37: 727-732, 2005; Lafrate et al., Nat. Genet., 36: 949-951, 2004; Sebat et al., Science, 305: 525-528, 2004).

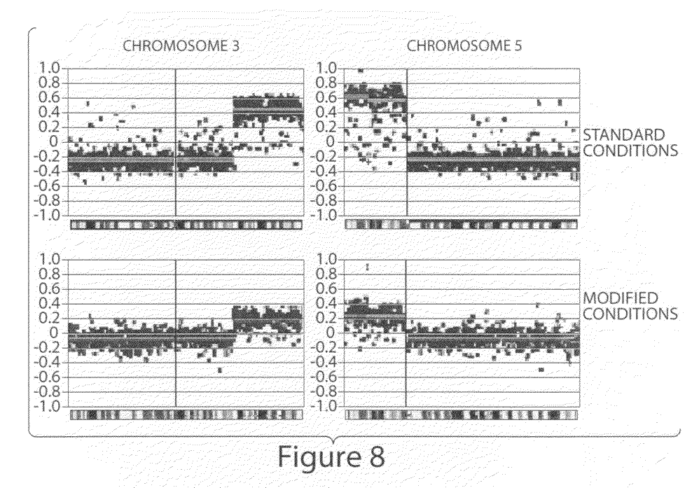

Using the standard BAC array conditions, several copy number changes were detected and verified by the dual array hybridization method and device. These same copy number changes were observed using the modified oligonucleotide conditions, however the magnitude of change was decreased (FIG. 8).

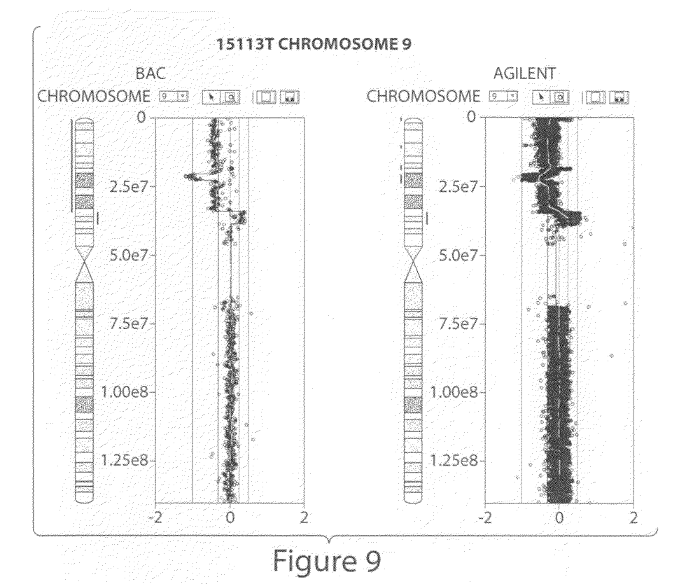

As seen in FIG. 9 individual aCGH analyses using BAC and Agilent platforms clearly identified the same general regions of change on chromosome 9 of a HNSCC tumor sample. The BAC array plot yielded tighter, more visually apparent breakpoints while the Agilent array plot shows more definition to the breakpoints. To take advantage of the strengths of both platforms, an embodiment of the invention herein provides a method that uses microarray methodologies such that the same labeled-probe pair is simultaneously hybridized to both the 19K BAC and 244K Agilent arrays. The two independent hybridizations are performed together using common reagents and conditions to achieve the desired aCGH results from a single biological sample to target elements on both platforms.

What is claimed is:

1. A device for performing simultaneous dual array comparative genomic hybridizations using a single aqueous sample of nucleic acid, the device comprising:
a first substrate array having a first array printed surface and a first array non-printed surface, wherein the first array comprises a first plurality of sequence targets, each target immobilized to a discrete and known spot on the first array printed surface;
a gasket adjacent to and in contact with the first array printed surface, wherein the gasket forms a liquid-tight seal with the first array printed surface;
a second substrate array having a second array printed surface and a second array non-printed surface, wherein the second array comprises a second plurality of sequence targets, each target immobilized to a discrete and known spot on the second array printed surface, wherein the second array printed surface contacts the gasket and the gasket forms a liquid-tight seal with the second array printed surface; and
a clamping device, wherein the clamping device has a cooperative relationship with the first array non-printed surface and the second array non-printed surface, wherein the sample is contracted to the first substrate and the second substrate, to perform simultaneous dual array.

2. The device according to claim 1, wherein the clamping device comprises at least one selected from the group of: an epoxy layer between the gasket and each of the first array printed surface and the second array printed surface; a chamber with two rails; at least one elastic band; at least one strap; at least one hinge attached to each of the first substrate array and the second substrate array, wherein the first substrate array and the second substrate array are rotationally moveable by varying the angle of opening of the hinge; a vacuum seal; electromagnets; comprises two or more frames wherein at least one frame is magnetic; a cam; a coil spring; a leaf spring; pneumatic pressure; hydraulic pressure; a wedge; a toggle; metal clips; plastic clips.

3. The device according to claim 1, wherein the gasket comprises deformable material.

4. The device according to claim 1, wherein the deformable material is at least one material selected from the group consisting of rubber and plastic.

5. The device according to claim 4, wherein the rubber is selected from the group of natural and synthetic.

6. The device according to claim 4, wherein the rubber further comprises at least one material selected from the group consisting of latex, silicone, and liquid silicone.

7. The device according to claim 4, wherein the plastic is at least one polymer selected from the group consisting of polyurethane, polyurethane foam, polyethylene, polypropylene, polybutylene, polystyrene, and polymethylpentene.

8. The device according to claim 7, wherein the plastic polymer further comprises at least one atom selected from the group consisting of oxygen, chlorine, fluorine, nitrogen, silicon, phosphorous, and sulfur.

9. The device according to claim 1, wherein the immobilized sequence targets comprise at least one polynucleotide selected from the group consisting of: genomic DNA, mitochondrial DNA, cDNA, RNA, mRNA, tRNA, rRNA, siRNA, RNAi, and dsRNA.

10. The device according to claim 1, wherein the first array sequence targets are substantially the same as the second array sequence targets.

11. The device according to claim 1, wherein the first array sequence targets are different from the second array sequence targets.

12. The device according to claim 1, wherein the first array resolution ability is substantially the same as the second array resolution ability.

13. The device according to claim 1, wherein the resolution ability of the first array is different from that of the second array.

14. The device according to claim 1, wherein the resolution ability of the first array is substantially equivalent to that of the second array.

15. The device according to claim 1, wherein each sequence of the sequence targets is printed in a plurality of replicates on each of the first array and the second array.

16. The device according to claim 15, wherein the plurality of replicates comprise at least one different amount of at least one immobilized sequence target.

17. The device according to claim 1, wherein the immobilized sequence targets are covalently bound to a component of the substrate surfaces.

18. The device according to claim 1, further comprising at least one immobilized sequence target spot as a positive control.

19. The device according to claim 1, further comprising at least one spot as a negative control.

20. The device according to claim 19, wherein the negative control for human immobilized sequence targets is selected from at least one genomic nucleic acid consisting of: non-animal; non-vertebrate; non-mammalian; non-primate; and non-human.

21. The device according to claim 19, wherein the negative control for is selected from at least one genomic nucleic acid obtained from an organism consisting of: a prokaryote; a zebra fish; a virus; and a plant.

22. A device for performing simultaneous dual binding assays using a single sample, the device comprising:
a first substrate array having a printed surface and a non-printed surface, wherein the first array comprises a first plurality of sequence targets, each target immobilized to a discrete and known spot on the first array printed surface;
a gasket adjacent to and in contact with the first array printed surface, wherein the gasket forms a liquid-tight seal with the first array printed surface;
a second substrate array having a printed surface and a non-printed surface, wherein the second array comprises a second plurality of sequence targets, each target immobilized to a discrete and known spot on the second array printed surface, wherein the second printed surface contacts the gasket and the gasket forms a liquid-tight seal with the second array printed surface; and
a clamping device, wherein the clamping device has a cooperative relationship with the first array non-printed surface and the second array non-printed surface.

23. The device according to claim 22, wherein the sequence targets are polynucleotides or polypeptides.

24. A method for performing simultaneous dual array comparative genomic hybridizations with a single sample, the method comprising:
co-hybridizing simultaneously a mixture of a labeled test sample and a differently labeled reference sample to a first array of sequence targets on a first substrate surface and a second array of sequence targets on a second substrate surface, wherein the co-hybridizing comprises contacting an aliquot of the mixture to both of the first array and second array simultaneously, wherein the first array substrate surface and the second array substrate surface are physically discrete, and wherein the first array is a first plurality of sequence targets, each target immobilized to a discrete and known spot on the first substrate surface to form the first array of sequence targets, and the second array is a second plurality of sequence targets, each target immobilized to a discrete and known spot on the second substrate surface to form the second array of sequence targets.

25. The method according to claim 24, wherein prior to co-hybridizing, the method comprises labeling the test sample, and labeling the reference sample, wherein the test sample and the reference sample are differently labeled.

26. The method according to claim 24, wherein after cohybridizing, the method further comprises detecting co-hybridization of each of the labeled test sample and the differently labeled reference sample to each of the first array and the second array.

27. The method according to claim 26, wherein the labeled test sample and the differently labeled reference sample are calorimetrically or fluorescently labeled, and detecting is performed by a laser scanner.

28. The method according to claim 24, further comprising comparing an intensity of a signal from the labeled test sample hybridized with the differently labeled reference sample on the sequence targets to obtain a signal ratio.

29. The method according to claim 28, further comprising comparing the signal ratios at each discrete and known spot of the sequence targets of the first array with the signal ratios at each discrete and known spot of the sequence targets of the second array, thereby evaluating relative copy numbers of sequences present in the labeled sample compared to the reference sample that are bound to the sequence targets of each of the first and second arrays.

30. The method according to claim 24, wherein the sequence targets are at least one polynucleotide selected from the group consisting of: genomic DNA, mitochondrial DNA, cDNA, RNA, mRNA, tRNA, rRNA, siRNA, RNAi, and dsRNA.

31. The method according to claim 24, wherein each of the test sample and the reference sample is at least one polynucleotide selected from the group consisting of: genomic DNA, mitochondrial DNA, cDNA, RNA, mRNA, tRNA, rRNA, siRNA, RNAi, and dsRNA.

32. The method according to claim 25, wherein prior to labeling, the test sample is obtained from at least one biological specimen selected from the group consisting of: a tissue; an embryo; a previously frozen embryo; an archived biopsy; a blood cell fraction; fractioned blood; embryonic cells obtained from maternal blood; urine; cerebral spinal fluid; amniotic fluid; cells obtained from amniotic fluid; chorionic villus; and an embryonic cell or embryo tissue.

33. The method according to claim 25, wherein the first array sequence targets are substantially the same as the second array sequence targets.

34. The method according to claim 25, wherein the first array sequence targets are different from the second array sequence targets.

35. The method according to claim 25, wherein the first array resolution ability is substantially the same as the second array resolution ability.

36. The method according to claim 25, wherein the first array resolution ability is different from the second array resolution ability.

37. A method for performing simultaneous dual array binding assays with a single sample, the method comprising:
co-contacting simultaneously a mixture of a labeled test sample and a differently labeled reference sample to a first array of sequence targets on a first substrate surface and a second array of sequence targets on a second substrate surface, wherein the co-contacting comprises contacting an aliquot of the mixture to both of the first array and second array simultaneously, wherein the first array substrate surface and the second array substrate surface are physically discrete, and wherein the first array is a first plurality of sequence targets, each target immobilized to a discrete and known spot on the first substrate surface to form the first array of sequence targets, and the second array is a second plurality of sequence targets, each target immobilized to a discrete and known spot on the second substrate surface to form the second array of sequence targets.

38. The method according to claim 37, wherein the sequence targets are polypeptides or polynucleotides.

39. The method according to claim 38, wherein the labeled test sample comprises a plurality of low molecular weight compositions.
